(19) United States
(12) Patent Application Publication
(10) Pub. No.: US 2013/0022524 A1
(43) Pub. Date: Jan. 24, 2013

(54) CATALYST FOR THE PHOTOCALYTIC TREATMENT OF GASEOUS MEDIA CONTAINING CARBON MONOXIDE

(71) Applicants: Olivier Rosseler, Saint - Avold (FR); Alain Louvet, Bretigny Sur Orge (FR); Nicolas Keller, Holtzheim (FR); Valerie Keller-Spitzer, Oberschaeffolsheim (FR)

(72) Inventors: Olivier Rosseler, Saint - Avold (FR); Alain Louvet, Bretigny Sur Orge (FR); Nicolas Keller, Holtzheim (FR); Valerie Keller-Spitzer, Oberschaeffolsheim (FR)

(73) Assignee: Centre National De La Recherche Scientifique (C.N.R.S), Paris (FR)

(21) Appl. No.: 13/392,029

(22) PCT Filed: Aug. 24, 2010
(86) PCT No.: PCT/FR10/51761

§ 371 Date: Oct. 2, 2012

(30) Foreign Application Priority Data
Aug. 24, 2009 (FR) 0955755

(51) Int. Cl. B01J 23/89; B01D 53/62

(52) U.S. Cl. 423/245.3; 502/326

(57) ABSTRACT

The present invention relates to catalytic compositions for, inter alia, the photocatalytic oxidation of CO, including: a substrate including, at least at a surface thereof, titanium oxide; and, deposited on the titanium oxide on the surface of the substrate, a metal mixture containing: platinum, at least partially in the metal state; and palladium and/or nickel, at least partially in the metal state. More specifically, the invention relates to the use of said compositions for treating gaseous media including CO and organic pollutants, for example indoor air in inhabited buildings or vehicles.

### BACKGROUND

The present invention relates to the field of purification of gaseous media polluted by gases or aerosols, in particular of gaseous media containing carbon monoxide (CO).

The invention more specifically relates to a depollution technique by photocatalytic oxidation, which allows treatment of gaseous media polluted both by CO and by other gaseous or aerosol pollutants such as volatile organic compounds (so-called “VOCs”). This depollution technique which may be used, including in the presence of humidity and at a room temperature, proves to be in particular suitable for achieving multi-pollutant treatment of air present in confined environments, in particular air present in inhabited buildings or vehicles (so-called “indoor air”) which most often comprise CO and VOCs as pollutants.

To this day, methods are known for treating gaseous media containing pollutants of the CO type and volatile organic compounds, which however do not prove to be adapted to specific treatment of inhabited confined atmospheres of the aforementioned type.

As regards the treatment of gaseous media comprising carbon monoxide, methods have notably been described wherein the CO is thermally converted into CO₂ in the presence of a catalyst based on a noble metal, generally gold. These methods, especially intended for treating industrial gas flows or automobile exhaust gas flows, are not adapted to the treatment of the indoor air of a room or of an inhabited vehicle. Indeed, they require that the gaseous medium to be treated be brought to high temperatures (typically above 80° C., generally of the order of 100 to 500° C.). Further, they have the drawback of applying catalysts containing a non-negligible amount of precious metal which is expressed in terms of a relatively prohibitive cost.

As regards the treatment of organic pollutants in a gaseous medium, there exist commercial devices intended for removing at room temperature this type of organic pollutants present in the indoor air of confined environments, notably inhabited environments. These devices typically apply a photocatalyst based on titanium oxide (TiO₂) in order to achieve photocatalytic oxidation of the organic pollutants upon contact with the photocatalyst in the presence of oxygen from the air. This photocatalytic oxidation has inter alia, the advantage of being able to be conducted at room temperature and optionally in the presence of humidity, which allows direct treatment of the air present in the confined environment to be cleaned up.

In the devices of this type, the titanium oxide is photoactivated by irradiation with photons of an energy greater than or equal to the energy required for promoting electrons from its valence band to its conduction band (typically radiation comprising wavelengths of less than 380 nm (UVA), and/or visible radiations in the case of the presence of titanium oxide of the rutile form). The organic pollutants which come into contact with the thereby photoactivated titanium oxide are oxidized photocatalytically, which typically leads to a conversion of the organic pollutants into less harmful mineral compounds such as CO₂, H₂O (or else mineral species of the sulfate or nitrate type in the case when the initial organic pollutants contain sulfur or nitrogen respectively).

The devices for removing organic pollutants using photoactivated TiO₂ of the aforementioned type are certainly potentially efficient for treating a large range of pollutants. However, despite these advantages, they do not prove to be fully satisfactory for treating confined atmospheres. Indeed, they do not allow parallel treatment of carbon monoxide which is however considered today as one of the problematical toxic pollutants of first rank present in confined environments.

More specifically, catalysts using photoactivated TiO₂ of the aforementioned type do not allow efficient conversion of CO into CO₂ and this all the more since the humidity content is high in the gas flow to be treated. Consequently, the purification devices presently known which use photoactivated TiO₂, do not prove to be suitable for practical treatment of inhabited confined environments which generally contain humidity and carbon monoxide.

### SUMMARY

An object of the present invention is to provide a novel method with which it is possible to efficiently purify a gaseous medium comprising carbon monoxide and this from room temperature upwards and including the presence of humidity.

More specifically, the invention sets the goal of being able to globally and efficiently treat a gaseous medium comprising both carbon monoxide and organic pollutants. Within this scope, the invention notably sets the goal of providing a means for efficiently and globally treating indoor atmospheres of confined environments, such as indoor air of buildings or vehicles.

In order to achieve these goals, the present invention proposes the use of a novel type of photocatalytic composition, the inventors of which have now demonstrated that it gives the possibility by itself to efficiently convert by photocatalytic oxidation both carbon monoxide and organic pollutants in a gaseous medium comprising these pollutants as a mixture.

More specifically, according to a first aspect, the object of the present invention is a catalytic composition (C) which comprises:
a substrate comprising at the surface thereof, at least titanium oxide; and deposited on the titanium oxide present on the surface of the substrate, a mixture of metals containing:
   platinum (Pt) at least partly in the metal state; and
   palladium (Pd) and/or nickel (Ni) at least partly in the metal state.

The work which was conducted by the inventors within the scope of the present invention have now allowed to demonstrate that a catalytic composition (C) as defined above may be efficiently used for achieving photocatalytic oxidation of carbon monoxide contained in a gaseous medium. The specific use of the catalytic composition (C) of the invention, which generally leads to quantitative conversion of carbon monoxide into OC₂, is another particular object of the present invention, as well as the catalytic compositions (C) of the aforementioned type which are specifically intended for carrying out photocatalytic oxidation of carbon monoxide contained in a gaseous medium.

The inventors have now established that when CO is put into contact in the presence of oxygen with the catalytic composition (C) in the photoactivated state (i.e. irradiated by photons with an energy greater than or equal to the energy required for promoting the electrons from the valence band of TiO₂ towards the conduction band, typically by radiation comprising wavelengths of less than 380 nm), a particularly efficient and quantitative conversion of CO into CO₂ is observed. The inventors have further noticed that within the scope of the present invention that the conversion of CO by means of a composition (C) of the aforementioned type may be achieved at room temperature and under atmospheric pressure and this either in the presence of humidity or not.

Further, the inventors have now brought to light that a catalytic composition (C) according to the present invention gives the possibility of achieving an efficient photocatalytic oxidation of organic compounds of the VOC type, and this unexpectedly as compared with the known properties of catalysts based on TiO₂ of present air purification devices. This efficiency is maintained when the treated medium contains carbon monoxide and this inclusive in the presence of humidity.

In other words, contrary to all expectations, the inventors have now demonstrated a photocatalytic composition which allows global and efficient treatment of atmospheres comprising both carbon monoxide and organic pollutants, and this from room temperature upwards, and even in the presence of humidity.

Further, still more surprisingly, it is found that particularly interesting catalytic properties of the compositions of the invention are obtained, including with relatively small amounts of metals deposited on the surface of the substrate. Indeed, more noticeable effects are observed with amounts of added metals of the order of a few 0.1% by mass based on the total mass of the catalyst, (which represents about at least 10 times less than the amounts of noble metals required in catalysts for heat treatment of CO, described above in the present description). Consequently, even though the compositions of the invention comprise relatively expensive metals (Pt and Pd in particular), the latter are present in sufficiently small amounts so as not to affect too consequently the cost of the catalytic compositions of the invention and not to form an obstacle to their practical exploitation.

These particularly interesting properties of the compositions (C), which have been demonstrated within the scope of the present invention, open the road to a global and efficient treatment of the indoor air of confined environments via a photocatalytic route, which presently remained out of the question considering the presently known photocatalysts.

Within this scope, according to a specific aspect, the object of the invention is also a method for treating a gaseous medium comprising carbon monoxide and organic compounds where said gaseous medium is put into contact with the aforementioned catalyst in the photoactivated state, in the presence of oxygen (generally present in the gaseous medium to be treated), whereby efficient catalytic oxidation is achieved both of carbon monoxide and of organic compounds. The object of the invention is in particular the treatment methods of this type where the gaseous medium to be treated is the indoor air of an inhabited building or vehicle.

### DETAILED DESCRIPTION

Different advantages, characteristics and preferential embodiments for producing different aspects of the invention will now be described in more detail.

The substrate based on titanium oxide which is present in the catalytic compositions (C) according to the invention comprises titanium oxide, at least at all or part of its surface. Generally the substrate dictates the structure of the catalytic composition and gives it in particular its mechanical properties, the presence of the metal deposited on the substrate not generally modifying these mechanical properties. Generally, this substrate comprises titanium oxide as a majority constituent (typically titanium oxide is present in the substrate in an amount of at least 60% by mass, or even at least 80% by mass and preferentially at least 90% by mass based on the total mass of the substrate). According to an embodiment particularly well adapted to the application of the invention, the substrate essentially or even entirely consists of titanium oxide (present in an amount of at least 95% by mass, more preferentially at least 98%, or even 99%). Alternatively, a catalytic composition according to the invention may also comprise a generally inert titanium oxide deposit on a base material (for example a porous base material capable of playing the role of a filter).

The titanium oxide present in the catalytic compositions (C) generally appears in the anatase and/or rutile form. According to a possible embodiment, this is anatase (photoactivatable by radiations of the UVA type, with a wavelength typically less than 380 nm), optionally in association with rutile (the mixture being then activatable in a known way by the aforementioned UVA radiations, as well as to a lesser extent by radiations with wavelengths of visible light). The titanium oxide used in the catalytic composition (C) is preferably a mixture comprising TiO₂ in the anatase form and TiO₂ in the rutile form, with an anatase/rutile mass ratio preferably comprised between 10:90 and 90:10, more preferentially between 50:50 and 85:15, this ratio being preferably greater than 70:30, for example of the order of 80:20.

More generally, the substrate used according to the invention may be selected from materials based on titanium oxide used as photocatalysts in presently known air purification devices based on photoactivated TiO₂.

Regardless of its exact composition, the substrate present in a catalytic composition according to the invention preferably appears as a solid material having a specific surface area as high as possible, and this notably so as to be able to optimize the exchanges with the gas flow to be treated. For this purpose, it is preferable that the BET specific surface area of the substrate be greater than 5 m²/g, more preferentially greater than or equal to 10 m²/g, for example between 50 and 500 m²/g.

The metal mixture which is deposited on the TiO₂ in a catalyst according to the invention is a mixture comprising at least two metals, i.e. platinum associated with palladium and/or nickel. The inventors have now demonstrated that the presence of this specific metal deposit on the surface of the titanium oxide, probably by electronic effects of the metal/semi-conductor and/or metal/metal type, leads to an improvement in the catalytic properties of the titanium oxide.

On this matter, the inventors have shown that the improvement of the properties obtained with the specific mixture of metals used according to the present invention (i.e. Pt associated with Pd and/or Ni) provides a quite particular catalytic effect not described to this day to the knowledge of the inventors, and which is not obtained by depositing other metals at the surface of the titanium oxide, which makes the observed improvement quite unexpected.

In particular, the inventors have established that a metal deposit exclusively consisting of platinum metal (and therefore free of Pd or Ni) on the titanium oxide does not lead to the photocatalytic properties observed within the scope of the invention. On the contrary, the inventors have notably shown that a TiO₂ catalyst only modified by platinum has insufficient efficiency for photocatalytic oxidation of organic pollutants, in particular in the presence of carbon monoxide.

Moreover, the inventors have shown that if the metal mixture used according to the invention is replaced with another mixture of metals, a drastic loss of catalytic activity is often obtained. This is notably the case when a deposition of a mixture of platinum and of a metal other than palladium or nickel is carried out. For example, a mixture of platinum and cobalt or else a mixture of platinum and iron deposited on the titanium oxide leads to a catalyst which is not able to efficiently ensure either photocatalytic oxidation of CO, or that of organic pollutants of the VOC type.

The mixture of metals deposited on the surface of the substrate of a catalytic composition (C) according to the invention is preferably present in a content greater than or equal to 0.05% by mass, more preferentially greater than or equal to 0.1% based on the total mass of the catalytic composition. The effects obtained by the catalytic improvement are dependent on this content, but generally it does not prove to be necessary to apply contents greater than 2% by mass in order to obtain efficient conversions of CO and of organic pollutants with the compositions according to the invention. Thus, the content of the mixture of metals deposited on the surface of the substrate of a catalytic composition (C) according to the invention is most often comprised between 0.1% and 2%, advantageously between 0.2% and 1%, for example between 0.25% and 0.75% (typically of the order of 0.3%) based on the total mass of the catalytic composition.

In the most general case, the platinum proportion present within the mixture of metals deposited on the substrate of a catalytic composition (C) according to the invention, expressed by the ratio of the number of moles of platinum metal present in the mixture to the number of moles of metal in the metal state present in the mixture is, as for it, preferably comprised between 10 and 90% by moles more preferentially between 30 and 80%.

Moreover, the mixture of metals present on the surface of the substrate of a catalytic composition (C) is preferably an intimate mixture of constitutive metals of the mixture. According to a particularly interesting embodiment, the mixture of metals present in a catalytic composition (C) according to the invention appears as a multitude of metal particles (“clusters”), deposited on the surface of the substrate, typically having dimensions comprised between 1 and 50 nm, preferably between 1 and 10 nm. These particles may comprise a mixture of several types of particles having variable Pt and Pd and/or nickel compositions. For example, the mixture of metals present on the surface of the substrate of a catalytic composition (C) may comprise a mixture of particles comprising particles consisting of Pt and particles consisting of Pd or consisting of Ni, optionally in association with particles comprising a mixture of Pd and of Pd or Ni. Alternatively, the mixture of metals may comprise a mixture of particles each comprising the Pd and Pd or Ni metals as a mixture, the composition being able to vary from one particle to another or else all the particles having the same composition.

The deposition of the mixture of metals onto the substrate of a catalytic composition according to the invention may be carried out according to any technique known per se. In particular, a catalytic composition according to the invention may advantageously be prepared according to a method comprising the following successive steps:
(a) putting a substrate material comprising at least at the surface thereof titanium oxide in contact with a solution (s) containing, in the solubilized state in said solution (s):
   at least one compound comprising platinum in an oxidation state greater than 0 and
   depending on the metals, the presence of which is sought in the catalyst, at least one compound comprising palladium in an oxidation state greater than 0 and/or at least one compound comprising nickel in an oxidation state greater than 0,
   whereby a platinum and palladium and/or nickel deposit is obtained in an oxidation
   state greater than 0 at the surface of the titanium oxide of the supporting material; and then
(b) reducing at least one portion of the platinum and at least one portion of the palladium and/or nickel, thereby deposited at the surface of the titanium oxide of the supporting material, into platinum metal and into nickel metal and/or palladium metal, respectively.

This embodiment leads to the formation on the surface of the substrate of the catalytic composition, of a metal deposit consisting of particles based on a metal mixture, which generally have a homogeneous size distribution over the whole of the surface of the substrate.

Generally, the solubilized metal compounds applied in step (a) may comprise compounds containing metal elements Pt, Pd or Ni in an oxidation state greater than 0, typically in the oxidation state +1, +2, +3 or +4 (typically Pt in the +2 or +4 oxidation state, Pd in the oxidation state +1, +2 or +3 or Ni in the oxidation state +2 or +3). The total concentration of metal elements Pt, Pd and Ni in the solution (s) is preferably comprised between 10⁻⁵ and 10⁻³ mol/L. The concentration of the various compounds applied in the solution (s) of step (a) is generally selected so that the pH of the solution (s) is lower (preferably by at least 0.5 and preferably by at least 1 pH unit) at the isoelectric point of the titanium oxide present at the surface of the substrate material of step (a).

Generally, the solubulized metal compounds of step (a) are metal salts or complexes which typically comprise Pt⁴⁺ cations and Pd³⁺ and/or Ni²⁺ cations. Preferentially, these are metal salts or complexes which are soluble within the solution (s). According to a particularly preferred embodiment, these are water-soluble metal salts or complexes and the solution (s) is an aqueous solution, which has the advantage that step (a) may be conducted in water, as a unique solvent. This possibility is again an advantage of the compositions of the invention which has repercussions both in terms of respect for the environment, ease of application and of reduced production costs. Further, it should be noted that step (a) does not require the application of heating means or pressurization means (step (a) may advantageously be conducted at room temperature and at atmospheric pressure).

As water-soluble compounds based on platinum well adapted to step (a), mention may notably be made of H₂PtCl₆ or else further PtCl₄, or Pt(AcAc)₂

As regards the water-soluble compounds based on palladium which may be applied in step (a), mention may be made, in a non-limiting way, of (NH₄)₂PdCl₆ or still further Pd(AcAc)₂, PdCl₂, Pd(OAc)₄, or palladium nitrate, notably in its Pd(NO₃)₂.2H₂O form.

Moreover, water-soluble compounds based on nickel suitable for applying step (a) are for example nickel chloride NiCl₂, Ni(AcAc)₂, Ni(OAc)₂, or palladium nitrate, notably in its Ni(NO₃)₂.6H₂O form.

As the metal compounds applied in step (a) are often sensitive to light (in particular H₂PtCl₆ and (NH₄)₂PdCl₆), it proves to be often preferable to conduct step (a) away from light, so as to inhibit photoreduction of the metal cations into metals during this step.

In step (a), the putting of the supporting material in contact with the solution (s) may be carried out by any means, notably by impregnation, soaking or spraying. Generally it proves to be preferable in step (a) that the contact time of the solution (s) with the supporting material be as long as possible, notably so as to optimize adsorption of platinum, palladium and nickel metal cations at the surface of the TiO₂. Thus, step (a) is preferably conducted by immersing the supporting material within the solution (s) and by preferably leaving the supporting material and the solution in contact for a period of at least 15 minutes, for example between 30 minutes and 5 hours (typically for one hour), advantageously with stirring. Stirring is preferably as intensive as possible, the inventors having shown that the size of the metal particles formed on the substrate at the end of step (b) being all the smaller since the stirring velocity is high.

In step (b), the elements Pt and Pd and/or Ni, introduced in step (a) at an oxidation state greater than 0, are at least partly reduced (and preferably as completely as possible into Pt and Pd and/or Ni in the oxidation state 0 (metal state). This reduction in step (b) may be accomplished according to any means known per se able to form the sought mixture of metal platinum and of nickel and/or metal palladium at the surface of the supporting material.

According to a particularly advantageous embodiment, the reduction in step (b) is carried out by reacting the substrate treated in step (a) with a reducing agent of the metal hydride type, for example NaBH₄, LiAlH(OtBu)₃, SnCl₂ or H₂C₂O₄, this reducing agent being preferably used in great excess (preferably at least 1.5 and more preferentially at least twice the stoichiometry) relatively to the amount of metal cations. This treatment has the advantage of being able to be directly conducted on the medium obtained at the end of step (a). Further, like step (a), step (b) has the advantage that it may be conducted in an aqueous medium, under atmospheric pressure and at room temperature, which makes the global method particularly well adapted to an industrial application. The application of higher temperatures than room temperature is however not excluded in step (b), where the reduction may be carried out by thermal reduction or by photoreduction.

According to a particularly interesting embodiment, a catalytic composition according to the invention is obtained by applying the following steps:
immersing a supporting material comprising at least at the surface thereof, titanium oxide in an aqueous solution containing in the solubilized state (i) water soluble salts or complexes based on platinum cations (generally Pt⁴⁺); and (ii) water-soluble salts or complexes based on palladium cations (Pd³⁺) and/or nickel cations (Ni²⁺), for a period advantageously greater than 15 minutes; and then
adding to the obtained medium a reducing agent, typically a metal hydride of the NaBH₄ type.

More generally preparation methods applying steps (a) and (b) as defined above and which following the application of the aforementioned steps (a) and (b) are conducted at room temperature and at atmospheric pressure, prove to be particularly of interest.

A catalyst according to the invention is obtained, wherein the substrate has physical properties which are generally extremely similar to that of the supporting material used in step (a). Indeed, most frequently, the treatments of steps (a) and (b) do not affect the physical properties of the supporting material, notably insofar that they generally involve no pressurization or heat treatment.

Consequently, the aforementioned steps (a) and (b) may advantageously be applied by using as a supporting material, photocatalysts based on titanium oxide which are present in presently known commercial devices for purifying air, based on TiO₂.

Within this scope, with the present invention it is possible to notably improve the efficiency of these purification devices of a known type by providing them exclusively with a structural modification which is very easy to introduce and with a reasonable cost, i.e. the deposition of a specific mixture of metals as defined above onto the surface of the TiO₂ catalysts present in these devices. The methods for preparing catalytic compositions according to the invention from a titanium oxide photocatalyst of this type are preferably without any pressurization or heat treatment step.

Generally, regardless of their preparation method, two large types of catalytic compositions (C) according to the present invention may be distinguished, depending on the nature of the mixture of metals present on the surface of the substrate based on titanium oxide, i.e.
the compositions comprising palladium (Pd); and
the compositions comprising nickel (Ni).

These two great types of compositions generally have similar catalytic properties, with variable efficiencies depending on the compositions but involve processes which seem similar, which is probably due to the fact that palladium and nickel occupy the same column of the Periodic Table.

### Catalytic Compositions Based on a Platinum/Palladium Mixture

According to a first alternative of the invention, the mixture of metals deposited on the titanium oxide of the substrate of a composition (C) according to the invention comprises a mixture of platinum in the metal state and of palladium in the metal state, i.e. a metal mixture fitting the following general formula (I):

PtₓPd₁₋ₓ (I)

wherein x is a number generally comprised between 0.1 and 0.9.

Catalytic compositions according to this first alternative which prove to be of particular interest, are those wherein x is comprised between 0.2 and 0.8, notably between 0.2 and 0.7, for example those wherein x=0.2; x=0.37.

Preferably, according to this first alternative, the mixture of metals present on the titanium oxide of the substrate is formed by a metal mixture fitting formula (I), excluding any other metal in the metal state.

Preferably, according to this embodiment, the ratio of the mass of the metal mixture of formula (I) present on the catalyst to the total mass of the catalyst is preferably comprised between 0.1 and 1%, for example 0.2 and 0.5%, this ratio being typically of the order of 0.3%.

The deposition on the substrate of a composition according to the invention, of a mixture of metals fitting the aforementioned formula (II) with a given value of x is typically carried out by putting the substrate in contact with an aqueous solution containing:
a water-soluble platinum salt or complex, typically H₂PtCl₆; and
a water-soluble palladium salt or complex, notably (NH₄)₂PdCl₆,
with a molar Pt/Pd in ratio the aqueous solution being equal to x/(1−x),
   and then by reacting the substrate from this treatment with a reducing compound able to convert the platinum cations into platinum metal and the palladium cations into palladium metal, this reducing compound being typically NaBH₄ otherwise used in stoichiometric excess.

According to this embodiment, metal particles having a size of the order of 1 to 10 nm and which comprise Pt and Pd in the metal state are formed at the surface of the substrate. These particles may notably be observed on micrographs obtained by transmission electron microscopy.

Preferably, the catalytic compositions obtained within the scope of this first alternative are obtained by immersing the supporting material within the aqueous solution comprising the platinum and palladium salts or complexes, by letting the thereby obtained medium ripen for at least 15 minutes (for example between 30 minutes and 2 hours), and then by rapidly adding the reducing agent to the reaction medium preferably with stirring.

In the aqueous solution comprising the platinum and palladium salts or complexes applied according to this first alternative of the invention, the concentration of the platinum element is preferably comprised between 10⁻⁵ and 10⁻³ mol/L. The concentration of the palladium element is also advantageously comprised between 10⁻⁵ and 10⁻³ mol/L. The aqueous solution comprising the salts preferably has a pH from 3 to 5.

The catalytic compositions according to this first alternative may optionally comprise, in addition to the mixture of metals of formula (I), other compounds at the surface, for example Pt or Pd metal salts or complexes which have not been reduced during the reduction step.

### Catalytic Composition Based on a Platinum/Nickel Mixture

According to a second alternative of the invention, the mixture of metals which is deposited on the titanium oxide of the substrate of a composition (C) according to the invention comprises a mixture of platinum in the metal state and of nickel in the metal state, i.e. a metal mixture fitting the following general formula (II):

Pt_{y}Ni_{1-y} (II)

wherein y is a number generally comprised between 0.1 and 0.9.

The catalysts according to this alternative prove to be interesting notably considering the relatively reduced costs of nickel.

Catalytic compositions according to this second alternative which prove to be particularly interesting, are those wherein y is greater than 0.2, for example between 0.3 and 0.8, in particular those wherein y=0.23; or y=0.55.

Preferably, according to this second alternative, the mixture of metals present on the titanium oxide of the substrate is formed by a metal mixture fitting formula (II), excluding any other metal in the metal state.

Preferably, according to this embodiment, the ratio of the mass of the metal mixture of formula (II) present on the catalyst to the total mass of the catalyst is preferably comprised between 0.1 and 1%, for example between 0.2 and 0.5%, this ratio typically being of the order of 0.3%.

The deposition onto the substrate of a composition according to the invention of a mixture of metals fitting the aforementioned formula (II) with a given y value is typically achieved by putting the substrate into contact with an aqueous solution containing:
a water-soluble platinum salt or complex, typically H₂PtCl₆; and
a water-soluble nickel salt or complex, generally a salt such as NiCl₂,
with a molar Pt/Ni ratio in the aqueous solution equal to y/(1−y),

and then by reacting the supporting material stemming from this treatment with a reducing compound able to convert the platinum cations into platinum metal and the palladium cations into palladium metal (typically NaBH₄ preferably used in stoichiometric excess).

According to this embodiment, metal particles having a size of the order of 1 to 10 nm and which comprise Pt and Ni in the metal state are formed at the surface of the substrate. These particles may there also be detected by transmission electron microscopy.

Preferably the catalytic compositions obtained within the scope of the second alternative are obtained by immersing the supporting material within the aqueous solution comprising the platinum and nickel salts or complexes, by letting the thereby obtained medium ripen for at least 15 minutes (for example between 30 minutes and 2 hours), and then by rapidly adding the reducing agent to the reaction medium, preferably with stirring.

In the aqueous solution comprising the platinum and nickel salts or complexes applied according to the second alternative of the invention, the concentration of the platinum element is preferably comprised between 10⁻⁵ and 10⁻³ mol/L, the concentration of the nickel element itself being advantageously comprised between 10⁻⁵ and 10⁻³ mol/L. The aqueous solution comprising the salts preferably has a pH from 3 to 5.

The catalytic compositions according to the second alternative of the invention may optionally comprise, in addition to the mixture of metals of formula (II) other compounds at the surface, for example Pt or Ni metal salts or complexes not having been reduced during the reduction step.

The catalytic compositions of the invention in particular those of the two preferential alternatives which have just been described, prove to be catalysts of choice for achieving photocatalytic oxidation of CO and of volatile organic compounds, in particular in gaseous media comprising both of these types of pollutants, and this at room temperature and either in the presence or not of humidity. The catalytic compositions of the invention consequently prove to be suitable for removing CO and volatile organic compounds in most gaseous effluents, in particular in the indoor air of confined environments. The compositions of the invention allow efficient photocatalytic oxidation of most volatile organic compounds, in particular non-aromatic compounds such as acetone, methylethylketone, alcohols, aldehydes, carboxylic acids, or hydrocarbons, either saturated or not, as well as non-aromatic sulfur- or nitrogen-containing compounds.

As indicated above in the present description, the compositions of the invention may be used as a replacement for non-doped titanium oxide catalysts used today in commercial devices for air purification via a catalytic route, the catalysts may be used in these devices as a replacement for present catalysts, without having to further adapt the structure of these devices.

More generally, the catalytic compositions of the invention may be used in any device for photocatalytic treatment of a gas flow comprising CO and/or volatile organic compounds. In these devices, the catalytic composition is generally associated with irradiation means capable of activating it, typically an electromagnetic radiation source comprising a wavelength of less than or equal to 380 nm (and/or a source of visible light in the case when the catalytic composition comprises titanium oxide in the rutile form), and with means for putting the gas flow to be treated in contact with the thereby photoactivated catalysts.

In this type of device, the catalytic composition according to the invention may for example be deposited as an internal coating on all or part of a duct with which the gas flow to be treated may be conveyed within the device.

According to an interesting embodiment, the catalytic composition according to the invention may be deposited on a filter, the thereby modified filter then being able to provide a particularly complete treatment of a gas flow, for example the indoor air of a confined environment. With such a filter it is indeed possible to continuously treat a gas flow by retaining the fine particles (dust, microorganisms, pollen . . . ) present within this flow (effect of the filter) and by removing together the CO and/or organic pollutants present in the gas flow (effects due to the photocatalyst).

The present invention and its advantages will still further be illustrated by the examples hereafter, wherein the catalytic compositions according to the invention have been prepared and tested. These compositions have all been prepared from a commercial powdery titanium oxide, i.e. TiO₂ P25 marketed by Evonik (20% of rutile phase—80% of anatase phase; specific surface area of about 50 m²/g).

### EXAMPLE 1

Catalytic Composition C1: 0.3% by mass of (Pd_{0.63}Pt_{0.37}) on TiO₂

At room temperature (20° C.) and at atmospheric pressure (10⁵ Pa), 2 g of the aforementioned titanium oxide substrate were immersed in 200 mL of an aqueous solution comprising in the solubilized state, 8.26 mg of H₂PtCl₆ and 9.64 mg of (NH₄)₂PdCl₆ (a Pd/Pt molar ratio of 0.63:0.37−(Pd+Pt)/TiO₂ mass ratio of 0.3% by mass).

The thereby obtained medium was left with stirring for one hour, away from light, so as to allow adsorption of the metal complexes on the surface of the substrate, without leading to early photoreduction of the metal cations.

10 mg of NaBH₄ were then introduced into the medium in one go, maintained with stirring, and they were left to react for 15 minutes so as to let the reduction of the cations into metals operate.

The formation of a metal mixture with a global formula of Pd_{0.63}Pt_{0.37} was thereby obtained on the surface of the titanium oxide substrate, in the form of particles with dimensions of the order of 1 to 10 nm, observable with transmission electron microscopy.

The obtained suspension was filtered, the filtrate removed and the modified substrate was dried, whereby the catalytic composition Cl was obtained as 2 g of a powder which may be used in this condition as a photocatalyst according to the invention.

### EXAMPLE 2

### Catalytic Composition C2: 0.3% by Mass of (Pd_{0.8}Pt_{0.2}) on TiO₂

The procedure of Example 1 was reproduced except that in the first step, 2 g of the aforementioned titanium oxide substrate were immersed in 200 mL of an aqueous solution comprising, in the solubilized state, 5.01 mg of H₂PtCl₆ and 13.73 mg of (NH₄)₂PdCl₆(Pd/Pt molar ratio of 0.8:02).

At the end of this process, 2 g of catalytic composition C2 were obtained as a powder.

### EXAMPLE 3

### Catalytic Composition C3: 0.3% by Mass of (Ni_{0.45}Pt_{0.55}) on TiO₂

At room temperature (20° C.) and at atmospheric pressure (10⁵ Pa), 2 g of the aforementioned titanium oxide substrate were immersed in 200 mL of an aqueous solution comprising in the solubilized state, 12.8 mg of H₂PtCl₆ and 2.8 mg of NiCl₂ (Ni/Pt molar ratio of 0.45:0.55−(Ni+Pt)/TiO₂ mass ratio of 0.3% by mass).

The thereby obtained medium was left with stirring for one hour, away from light.

10 g of NaBH₄ were then introduced into the medium in one go, maintained with stirring, and were left to react for 15 minutes so as to let the reduction of the cations into metals operate, leading to the formation of bimetal particles of Ni_{0.45}Pt_{0.55} on the surface of the titanium oxide substrate.

The obtained suspension was filtered, the filtrate removed and the modified substrate was dried, whereby the catalytic composition C3 was obtained as 2 g of a powder which may be used in this condition as a photocatalyst according to the invention.

### EXAMPLE 4

### Catalytic Composition C4: 0.3% by Mass of (Ni_{0.77}Pt_{0.23}) on TiO₂

The procedure of Example 4 was reproduced except that in the first step, 2 g of the aforementioned titanium oxide substrate were immersed in 200 mL of an aqueous solution comprising in the solubilized state, 7.9 mg of H₂PtCl₆ and 6.6 mg of NiCl₂ (Ni/Pt molar ratio of 0.77:0.23).

At the end of this process, 2 g of catalytic composition C4 were obtained as a powder.

### EXAMPLE 5

### Photocatalytic Oxidation of Carbon Monoxide

The compositions C1, C2, C3 and C4 of the examples above were applied for achieving photocatalytic oxidation of a gas flow consisting of air added with 250 ppm of carbon monoxide (a CO concentration voluntarily selected to be very high and well above the lethal threshold of carbon monoxide).

The photocatalytic oxidation was achieved in each case in a tubular annular reactor with a length equal to 26 cm and an internal diameter equal to 3 cm. On the internal walls of this reactor, 110 mg of the relevant catalytic composition (C1, C2, C3 or C4 respectively) were deposited (covering level of the internal wall of the reactor: 0.125 g/cm²). To do this, the composition was dispersed in ethanol and the dispersion was applied on the internal wall of the catalyst, and then dried. The catalytic oxidation of the gas flow was performed by introducing the flow into the reactor at a flow rate of 200 mL/minute while irradiating the whole of the catalytic composition localized inside the reactor with a UVA lamp (380 nm-8 W) localized inside the reactor.

In each case, the reaction was reproduced under the same conditions, but by adding water within the treated gaseous medium (40% or relative humidity (RH) in this case, versus 0% in the first case).

As a comparison, the reaction was moreover always conducted under the same conditions, but with a TiO₂ P25 substrate (not modified) as a photocatalyst.

The obtained results are copied into the Table 1 below, which shows the unquestionable superiority of the catalysts of the invention as compared with TiO₂ of the type used in present air purification devices. Indeed, the CO conversion is 30% with a relative humidity (RH) of 0%, and is quasi-inexistent at 40% of relative humidity), the catalysts of the invention give the possibility of obtaining a much higher conversion rate, including the presence of humidity.

TABLE 1
CO conversion rate

| | | TiO₂ | C1 | C2 | C3 | C4 |
|---|---|---|---|---|---|---|
| CO conversion rate (%) | R = 0% | 30 | 100 | 100 | 85 | 70 |
| | RH = 40% | 4 | 100 | 45 | 100 | 100 |

### EXAMPLE 6

### Photocatalytic Oxidation of Carbon Monoxide

The compositions 01, C2, C3 and C4 of Examples 1 to 4 were applied in order to achieve removal within a gas flow of two types of pollutants present together, i.e. CO and acetone (an organic compound representative of the VOCs present in actual confined environments).

The treated gas flow is an air stream comprising 250 ppm of CO and 1,500 ppm of acetone, which was treated by photocatalytic oxidation under the same conditions as in Example 5 with or without humidity.

As a comparison, the same reaction was conducted with the TiO₂ P25 substrate (not modified) as a photocatalyst.

The obtained results are copied into the Table 2 below, which clearly shows the superiority of the catalyst according to the present invention as regards the conversion of CO in the presence of VOCs.

TABLE 2
Conversion rate of a CO and acetone mixture

| | | | TiO2 | C1 | C2 | C3 | C4 |
|---|---|---|---|---|---|---|---|
| Conversion | RH = 0% | CO | 27 | 100 | 90 | 20 | 25 |
| rate (%) | | Acetone | 95 | 100 | 80 | 90 | 97 |
| | RH = 40% | CO | 3 | 82 | 80 | 30 | 45 |
| | | Acetone | 100 | 100 | 75 | 65 | 80 |

1-13. (canceled)

14. A method for treating a gaseous medium comprising carbon monoxide and organic compounds, wherein said gaseous medium is put into contact with a catalytic composition in the photoactivated state, said catalytic composition comprising:
a substrate comprising at least at the surface thereof, titanium oxide; and
deposited on the titanium oxide present on the surface of the substrate, a metal mixture containing:
platinum, at least partly in the metal state; and
palladium and/or nickel, at least partly in the metal state in order to achieve photocatalytic oxidation of carbon monoxide contained in a gaseous medium;
in the presence of oxygen, whereby efficient catalytic oxidation is obtained both of carbon monoxide and of the organic compounds.

15. The method according to claim 14, wherein the treated gaseous medium is the indoor air of an inhabited building or vehicle.

16. The method according to claim 14, wherein the metal mixture deposited on the surface of the substrate, in the composition, is present in a content comprised between 0.1 and 2% based on the total mass of the catalytic composition.

17. The method according to claim 14, wherein the metal mixture deposited on the surface of the substrate, in the composition, appears as a multitude of metal particles.

18. The method according to claim 14, wherein the composition may be obtained according to a method comprising the following successive steps:
(a) putting a supporting material comprising at least at the surface thereof, titanium oxide, in contact with a solution (s) containing in the solubilized state, in said solution (s):
at least one compound comprising platinum in an oxidation state greater than 0; and
at least one compound comprising palladium in an oxidation state greater than 0 and/or at least one compound comprising nickel in an oxidation state greater than 0,
whereby a deposit of platinum and of palladium and/or nickel in an oxidation state greater than 0 is obtained at the surface of the titanium oxide of the supporting material;
and then
(b) reducing at least one portion of the platinum and at least one portion of the palladium and/or nickel thereby deposited at the surface of the titanium oxide of the supporting material, into platinum metal and nickel metal and/or palladium metal, respectively.

19. The method according to claim 14, wherein the metal mixture deposited on the surface of the substrate, in the composition, comprises a mixture of platinum metal and of palladium in the metal state, fitting the following general formula (I):
PtₓPd₁₋ₓ (I)
wherein x is a number comprised between 0.1 and 0.9.

20. The method according to claim 19, wherein the metal mixture of formula (I), in the composition, is deposited on the substrate by putting the substrate in contact with an aqueous solution containing:
a water-soluble platinum salt or complex; and
a water-soluble palladium salt or complex,
with a Pt/Pd molar ratio in the aqueous solution equal to x/(1−x),
and then by reacting the substrate stemming from this treatment with a reducing compound able to convert the platinum cations into platinum metal and the palladium cations into palladium metal.

21. The method according to claim 14, wherein the metal mixture deposited on the surface of the substrate, in the composition, comprises a mixture of platinum metal and of nickel in the metal state, fitting the following general formula (II):
Pt_{y}Ni_{1-y} (II)
wherein y is a number generally comprised between 0.1 and 0.9.

22. The method according to claim 21, wherein the metal mixture of formula (II), in the composition, is deposited on the substrate by putting the substrate into contact with an aqueous solution containing:
a water-soluble platinum salt or complex; and
a water-soluble nickel salt or complex;
with a Pt/Ni molar ratio in the aqueous solution equal to y/(1−y);
and then by reacting the substrate stemming from this treatment with a reducing compound able to convert the platinum cations into platinum metal and the nickel cations into nickel metal.

23. The method according to claim 18, wherein the soluble compounds used in step (a) are water-soluble metal salts or complexes comprising Pt⁴⁺ cations and Pd³⁺ and/or Ni²⁺ cations, and wherein the solution (s) is an aqueous solution.

24. The method according to claim 23, wherein in step (a) the water-soluble platinum salt or complex is H₂PtCl₆, PtCl₄, or Pt(AcAc)₂; the water-soluble palladium salt or complex is (NH₄)₂PdCl₆, Pd(AcAc)₂, PdCl₂, Pd(OAc)₄, or Pd(NO₃)₂.2H₂O; and the nickel salt or complex is NiCl₂ Ni(AcAc)₂, Ni(OAc)₂, or Ni(NO₃)₂.6H₂O.

25. A catalytic composition comprising:
a substrate comprising, at least at the surface, titanium oxide; and
deposited on the titanium oxide present on the surface of the substrate, a metal mixture containing:
platinum, at least partly in the metal state; and
palladium and/or nickel, at least partly in the metal state, wherein the metal mixture deposited on the surface of the substrate comprises a mixture of platinum metal and of nickel in the metal state, fitting the following general formula (II):
Pt_{y}Ni_{1-y} (II)
wherein y is a number generally comprised between 0.1 and 0.9.
